(19) United States
(12) Patent Application Publication
(10) Pub. No.: US 2008/0209810 A1
(43) Pub. Date: Sep. 4, 2008

(54) Door Suspension Assembly

(76) Inventor: Robert Mihekun Miller, Canton, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/065,331

(22) PCT Filed: Sep. 1, 2005
(86) PCT No.: PCT/US05/31042

§ 371 Date: Feb. 29, 2008

(51) Int. Cl. E05C 9/02

(52) U.S. Cl. 49/120

(57) ABSTRACT

A door suspension assembly (34) includes a door (24) moveable along an essentially straight path of door movement and a suspension (34) that supports the door (24) and establishes the path of door movement. The suspension (34) has a portion (44, 58, 62) that moves along a curved path when the door (24) moves along the essentially straight path of door movement.

### FIELD OF THE INVENTION

This invention generally relates to doors and, more particularly to a suspension for supporting a linear door.

### BACKGROUND OF THE INVENTION

Door suspension assemblies are utilized in linear door systems. An example of a linear door system is a door system for an elevator. A typical elevator system includes an elevator cab that moves within a hoistway between landings in a building, for example, to transport passengers, cargo or both between building levels. Typically, a hoistway entrance includes at least one elevator door and the cab also has at least one door. An actuator supported on the cab moves the cab and hoistway elevator doors between open and closed positions when the cab is stopped at a landing.

Elevator doors typically include a door suspension supporting the elevator doors. Each elevator door hangs from a set of rollers that roll along a track near the top of the hoistway entrance or cab. The bottom of each elevator door includes a gib that is received into a guide groove within a door sill near the bottom of the door. The gib follows the guide groove as the elevator door moves. The gib and guide groove also cooperate to keep the door plumb.

Typical guide grooves require significant maintenance. The guide groove is exposed to passengers and cargo entering and exiting the elevator cab. The passengers and cargo track dirt and debris that can accumulate in the guide groove. The accumulation may increase friction between the gib and the guide groove. If the accumulation is large enough, the elevator door may not move as desired within the guide groove. Therefore, typical guide grooves continually require cleaning to remove dirt and debris.

One proposed solution has been to include a passage at the ends of the guide groove. This approach introduces the possibility for a door gib to push debris into one of the passages. A drawback to this approach is that it complicates the design of the guide assembly. Additionally, this approach is not consistent enough to avoid periodic, manual cleaning.

Another drawback associated with conventional arrangements is that the rollers for hanging the door and the track are susceptible to wear and accumulations of dirt and debris. These factors introduce additional maintenance, which is generally undesirable. There are also issues associated with consistently achieving adequate traction to move the doors.

Another shortcoming of conventional arrangements is that door movement tends to be noisy because of the interaction between the various moving parts.

Another type of elevator door arrangement that does not use the traditional track and rollers is disclosed in U.S. Pat. Nos. 5,427,205 and 5,505,280. That type of arrangement is suitable for doors that follow an arcuate path but is not useful for replacing a track and rollers for moving an elevator door along a straight path.

There is a need for an improved door suspension that is quieter, requires less cleaning and less maintenance. This invention addresses those needs and provides enhanced capabilities while avoiding the shortcomings and drawbacks of the prior art.

### SUMMARY OF THE INVENTION

An exemplary door suspension assembly includes a linkage for suspending a door and establishing an essentially straight path of door movement. At least one link member of the linkage has a portion that moves along a curved path for moving a door along the essentially straight path of door movement. In one example, one end of the link member pivots about a stationary pivot point while an opposite end of the link member is connected with a crossbar associated with a door. In such an example, the end of the link member associated with the crossbar follows the curved path while the door moves along the straight path.

One example includes three link members that cooperate to suspend the door and to provide movement of the door as desired. In one example, two link members extend from a top of a door to a crossbar associated with the door while another link member extends between the crossbar and a position near a bottom of the door.

One example includes a bias member associated with at least one of the links for biasing the door toward a desired position. In one example, the links are arranged so that the bias operates to urge the door into a fully closed or a fully opened position.

An example door assembly includes a door and a first pivot member near one end of the door. A crossbar is rotatably connected to the elevator door. A first link extends between the crossbar and the first pivot member. A second pivot member is positioned near an opposite end of the elevator door. A second link extends between the crossbar and the second pivot member. The links and the crossbar cooperate to support the door and to selectively move the door.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically shows selected portions of an example elevator system including a door suspension assembly.

FIG. 2 shows selected portions of an example suspension assembly.

FIG. 3 shows a side view of selected portions of the suspension assembly of FIG. 2.

FIG. 4 shows selected portions of a rotatable joint that includes a compliant member.

FIG. 5 shows selected portions of the compliant member of FIG. 3 during movement of an elevator door.

FIG. 6 shows selected portions of a second embodiment of an example suspension assembly.

FIG. 7 shows selected portions of a third embodiment of an example suspension assembly.

### DETAILED DESCRIPTION OF THE PREFERRED EMBODIMENTS

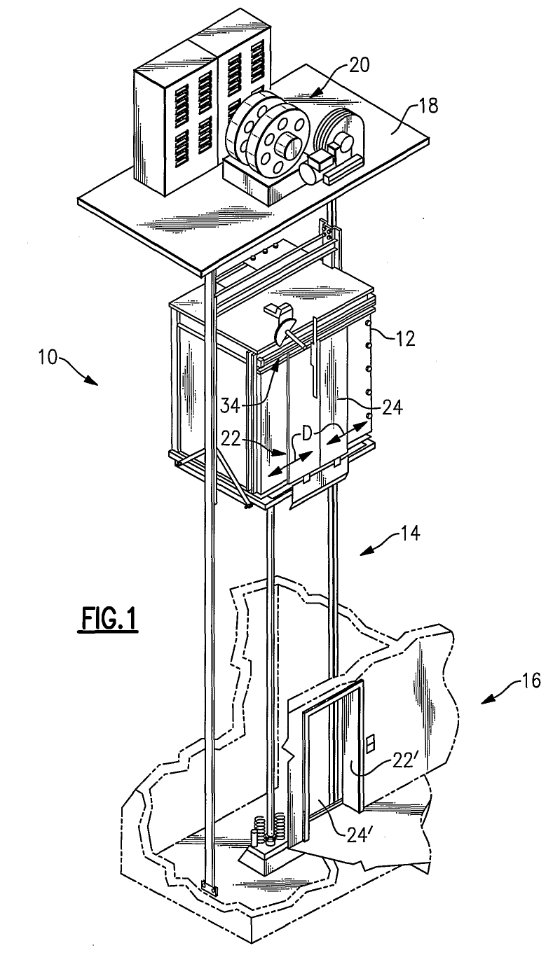

FIG. 1 shows selected portions of an example elevator system 10 that includes an elevator cab 12 that moves in a hoistway 14 between landings 16 of a building. In the example shown, a platform 18 above the elevator cab 12 supports an elevator machine 20. The elevator machine 20 moves the cab 12 in a generally known manner up and down in the hoistway 14 to transport cargo, passengers or both between landings 16.

The cab 12 includes an entrance 22 having elevator car doors 24 that move in a direction of door movement D between open and closed positions when the cab 12 is stopped at the landings 16. Each landing includes a corresponding entrance 22′ having corresponding elevator doors 24′ that move with the elevator car doors 24 of the cab 12 between the open and closed positions. Each door 24 and 24′ is supported by a suspension assembly 34 in the corresponding entrance 22.

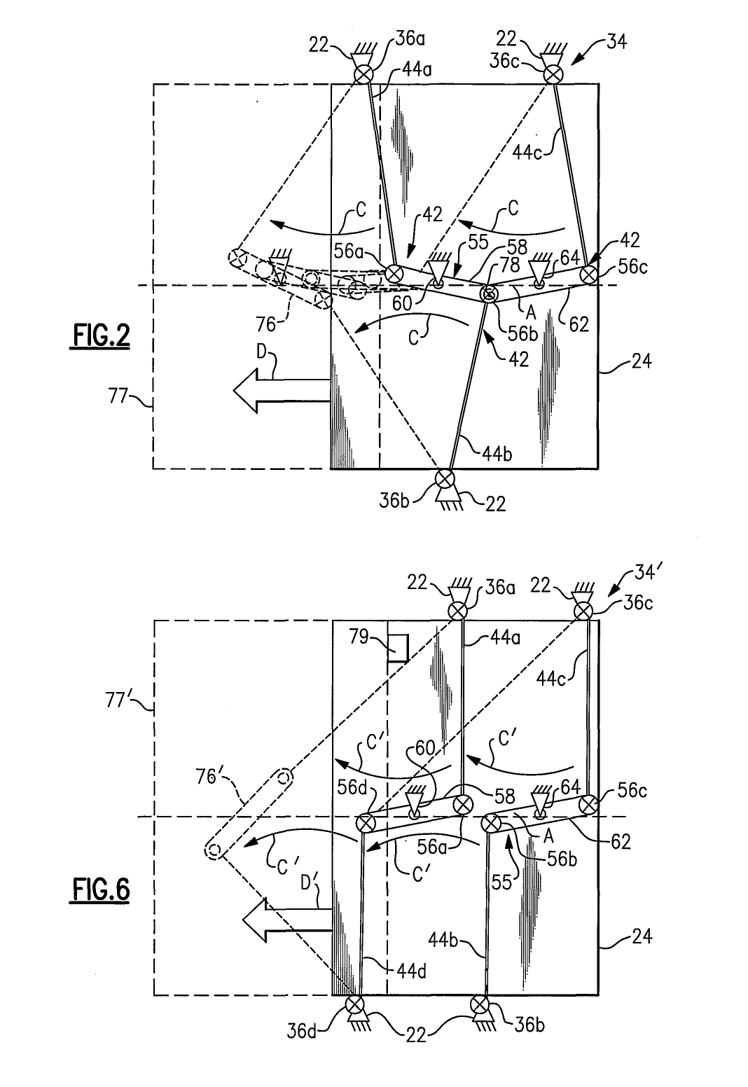

FIG. 2 shows selected portions of an example suspension assembly 34 that establishes an essentially straight path of movement of the elevator door 24, as indicated at D. The illustration shows the suspension assembly 34 supporting an elevator car door 24, however, the suspension assembly 34 is equally applicable to the elevator doors 24′.

In the illustrated example, the suspension assembly 34 includes a first pivot member 36a secured near one end of the elevator door 24 (above and to the left in FIG. 2). A second pivot member 36b is secured near an opposite end (below the elevator door 24 in FIG. 2). A third pivot member 36c is secured above the elevator door. In the illustrated example, the pivot members 36a, 36b, 36c include sealed bearings. Each pivot member 36a, 36b, 36c is secured to the entrance 22, for example. In one example, the entrance 22 includes an elevator cab frame member, however, given this description, those skilled in the art will be able to select an appropriate connection between the suspension assembly 34 and entrance 22 (or 22′) to meet their particular needs. In another example, the pivot members 36a, 36b, 36c are located within the envelope of the elevator door 24.

Each of the pivot members 36a, 36b, 36c supports one end of a linkage 42 that extends between the pivot members. The linkage 42 supports the weight of the example door 24. In one example, the elevator door 24 includes front and back panels and the linkage 42 is located between the front and back panels and hidden from view. The illustration in FIG. 2 shows only one such panel with the other removed to expose the linkage 42 to view.

In the illustrated example, the linkage 42 includes elongated link members 44a, 44b and 44c rotatably connected near one end to a corresponding pivot member 36a, 36b, 36c. In one example, each of the pivot members 36a, 36b, 36c includes a bearing that allows the corresponding elongated link member 44a, 44b, 44c to rotate or pivot about an axis of the corresponding pivot member. Another end of each link member is associated with a crossbar 55, which comprises a plurality of crossbar members in this example. The other end of each illustrated elongated link member 44a and 44b is connected by respective rotatable joints 56a and 56b to a first crossbar member 58. The first crossbar member 58 is rotatably connected to the car door 24 between front and back panels of the car door 24, for example, and is rotatable about a pivot point 60 between the rotatable joints 56a and 56b.

The other end of the elongated link member 44c is connected by a rotatable joint 56c to a second crossbar member 62. The second crossbar member 62 is rotatably connected to the car door 24 between the front and back panels of the car door 24, for example, and is rotatable about a pivot point 64. In the illustrated example, the pivot point 60 and pivot point 64 lie on a horizontal axis A.

One end of the second crossbar member 62 is connected to the elongated link member 44c and an opposite end of the second crossbar member 62 is rotatably connected to the first crossbar member 58 and elongated link member 44b at the rotatable joint 56b. In the illustrated example, the pivot members 36a, 36b, 36c, elongated link members 44a, 44b, 44c, and crossbar members 58, 62 are interconnected such that movement of the pivot members 36a, 36b, 36c, elongated link members 44a, 44b, 44c, and crossbar members 58, 62 causes movement of the door 24.

The pivot members 36a, 36b, 36c and the linkages 42 support the weight of the car door 24 in the entrance 22. In the illustrated example, the weight of the car door 24 is transferred through connections at the pivot points 60 and 64 to the crossbar members 58 and 62. The elongated link members 44a, 44b, 44c transfer the weight from the crossbar members 58 and 62 to the pivot members 36a, 36b, 36c, which are structurally connected to the entrance 22. In one example, the weight of the door 24 is evenly distributed among the link members 44a, 44b, 44c to provide uniform support of the door 24 and smooth door movement. In another example, the weight is disproportionately distributed among the link members 44a, 44b, 44c.

The example of FIG. 2 has three support locations outside the envelope of the door 24.

In the illustrated example, the door 24 is moveable between open and closed positions along an essentially straight path, as indicated by the arrow D. In one example, an actuator (not shown) moves the door 24 by causing rotation about the axis of at least one pivot member 36a, 36b or 36c. Another example moves the door by applying a linearly directed force to one of the link members 44a, 44b or 44c. Another example applies a linearly directed force directly to the door 24.

With any one of the just-mentioned activities each of the elongated link members 44a, 44b, 44c pivots about the respective pivot members 36a, 36b, 36c such that a portion of each link member moves along a curved path C when the door 24 moves along the essentially straight path D. The pivot members 44a, 44b, 44c allow the door 24 to move along the essentially straight path D but do not allow significant movement of the door 24 in directions transverse to the essentially straight path D. This example provides the benefit of establishing a path of movement for the door 24 without having to use a guide groove that can easily collect dirt and debris or a roller and track that are subject to wearing out over time.

During door movement, the first crossbar member 58 rotates about the pivot point 60 as indicted in phantom at 76. The elongated link members 44a, 44b, 44c each include a nominal length. The combination of the link members and the crossbar essentially prevents the door 24 from moving beyond the position at 77 along the essentially straight path D to establish one end of a range of possible door movement. Longer link members would increase the range of movement while shorter links decrease it.

The crossbar member 62 pivots about the pivot point 64 while the crossbar member 58 pivots about the pivot point 60 during door movement. The rotatable joint 56b in this example moves to a highest position (according to the drawing) when the door 24 is at an approximate midpoint of the possible range of movement. Even though the crossbar members 58 and 62 pivot about the pivot points 60 and 64, respectively, during door movement, the pivot points 60 and 64 remain fixed along a horizontal line A throughout the door movement to provide smooth and quiet door movement.

The pivotal connections between the link members, the crossbar members and the door allows for movement of the linkage in a manner that causes straight movement of the door 24. At the same time, the lengths of the various portions of the linkage are selected to provide the desired level of rigidity, stability and range of motion while supporting the weight of the door 24.

In the illustrated example, the nominal lengths together establish the fully open and closed positions of the door 24. In the illustrated example, the rotatable joint 56b includes a biasing member 78 to urge the door 24 toward one end of the range of movement and to resist movement of the door 24 away from that position. In one example, the biasing member 78 includes a spring and the direction of the bias urges the door 24 closed. In one example, the end of the link member 44b associated with the rotatable joint 56b includes a surface that cooperates with at least one end of the spring 78 such that movement of the link member 44b associated with moving the door 24 out of a closed position operates against the bias of the spring 78.

In another example, at least a portion of one of the pivot members 36a, 36b or 36c is associated with a spring that biases the pivot member and the associated link member in one direction. One example spring is arranged to resist rotation of the portion of the pivot member from a position corresponding to the door 24 being closed.

In another example, a predetermined mass is added to either the link members 44a, 44b, 44c or the rotatable joints 56a, 56b, 56c. The gravitational effect on the mass helps to limit upward travel of the elevator door 24 near the end of the range of movement.

In the example illustrated in FIG. 3, a thickness of the elevator door 24 is shown. In this example, the suspension assembly 34 is partially within the thickness of the elevator door 24. This provides the benefit of hiding the suspension assembly 34 from view.

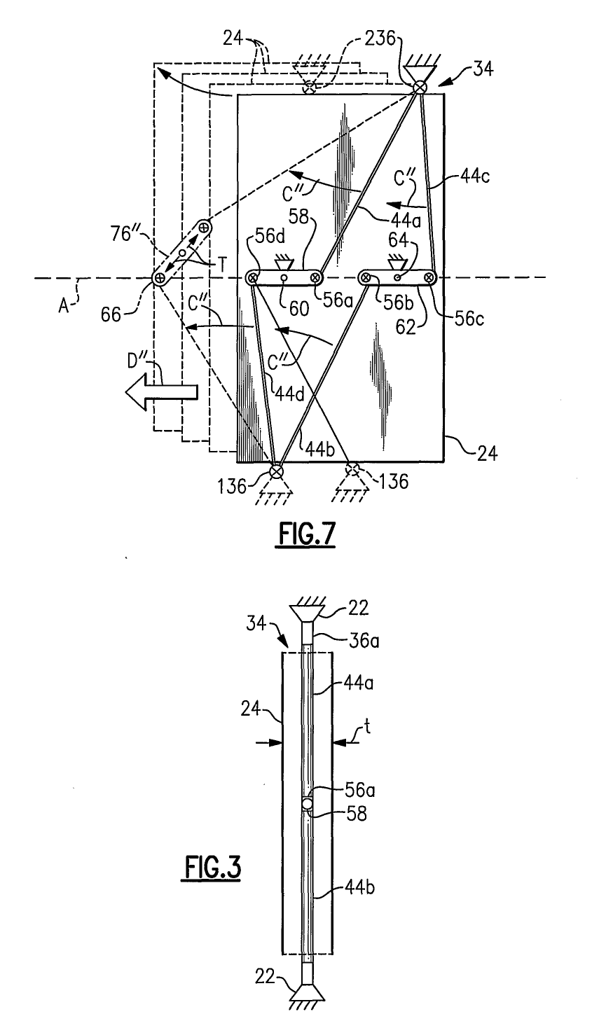

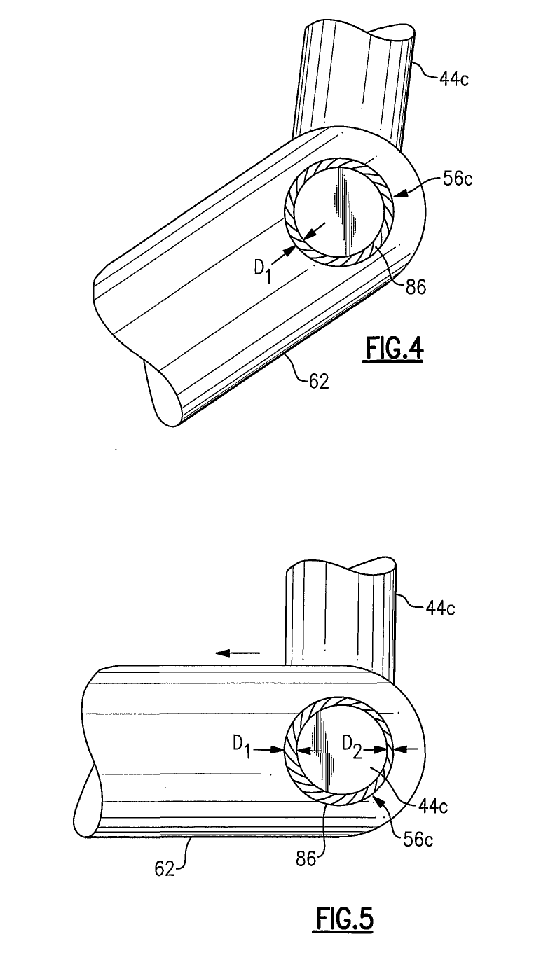

In the example illustrated in FIG. 4, the rotatable joint 56c includes a compliant member 86 between the elongated link member 44c and the second crossbar member 62. The compliant member 86 includes a nominal dimension D₁. At least a portion of the compliant member 86 compresses (FIG. 5) such that the dimension D₁ decreases to D₂ along that portion, for example, when the second crossbar member 62 rotates relative to the elongated link member 44c (i.e., when the elevator door 24 moves).

In the example illustrated in FIG. 5, the compression of the compliant member 86 allows selective play between the elongated link member 44c and the second crossbar member 62 at the rotatable joint 56c such that the elongated link member 44c can pivot about the pivot member 36c without restriction from the rigidity of the suspension assembly 34. In one example, the pivot members 36a, 36b, 36c, elongated link members 44a, 44b, 44c, and crossbar members 58, 62 are all rigid. The tension of the linkage that provides stable support for the door 24 would tend to lock up the linkage when an actuator attempts to move the elevator door 24. A compliant member 86 provides sufficient tension and rigidity for a stable linkage 42 under rest conditions while allowing an actuator to cause door movement. The additional force of the actuator tends to compress the compliant member 86, which selectively introduces enough slack in the linkage 42 to enable smooth door movement.

In another example, at least the elongated link member 44c is at least partially compliant rather than rigid to provide the same effect as the example compliant member 86.

FIG. 6 shows selected portions of a second embodiment of an example suspension assembly 34′. This example includes a fourth pivot member 36d secured to the elevator entrance 22 below and to the left of the door 24 in FIG. 5. A fourth elongated link member 44d is rotatably connected near one end to the pivot member 36d and connected near the other end by a rotatable joint 56d to the first crossbar member 58.

In the illustrated example, the first crossbar member 58 is connected on one end to the fourth elongated link member 44d and on the opposite end to the elongated link member 44a. In this example, the first crossbar member 58 rotates about the pivot point 60 independently of the second crossbar member 62. The second crossbar member 62 is connected on one end to the elongated link member 44b and on the opposite end to the elongated link member 44c and is rotatable about the pivot point 64 independent of the rotation of the first crossbar member 58. Although they are independently rotatable, the crossbar members move simultaneously as all four link members move to provide door movement.

In the illustrated example, the door 24 is moveable between open and closed positions along an essentially straight path, as indicated by the arrow D′. Each of the elongated link members 44a, 44b, 44c, 44d pivots about the respective pivot members 36a, 36b, 36c, 36d such that a portion of each link moves along a curved path C′ when the elevator door 24 moves along the essentially straight path D′. As the elevator door 24 moves, the crossbar member 58 rotates and ultimately moves into the position indicated in phantom at 76′. Similar to the example of FIG. 2, the elongated link members 44a, 44b, 44c, 44d each include a nominal length that establishes an open position of the elevator door 24 and prevents the elevator door 24 from moving beyond the position at 77′ along the essentially straight path D′. Optionally, a bumper 79 near the end of the range of travel of the elevator door 24 can be used to prevent further movement of the elongated link 44a (and the elevator door 20).

The example of FIG. 6 has four support locations outside the envelope of the door 24.

FIG. 7 shows selected portions of a third embodiment of an example suspension assembly 34″. This example includes a pivot member 136 secured to the elevator entrance 22 below the elevator door 24 and another pivot member 236 secured above the elevator door 24 and offset to the right (according to the drawing) of the lower pivot member 136. The elongated link members 44b and 44d are each rotatably connected near one end to the lower pivot member 136 and connected near an opposite end to the second crossbar member 62 and the first crossbar member 58, respectively. The elongated link members 44a and 44c are each rotatably connected near one end to the upper pivot member 236 and connected near opposite ends, respectively, to the first crossbar member 58 and the second crossbar member 62.

In the illustrated example, the door 24 is moveable between open and closed positions along an essentially straight path, as indicated by the arrow D″. Each of the elongated link members 44a, 44b, 44c, 44d has a portion that follows along a curved path C″ when an actuator (not shown) moves the door 24. In this example configuration, the first crossbar member 58 is indicated in phantom at 76″ and swings upwards relative to the horizontal axis A at 76″. The swinging upward is a result of a tension T on the first cross bar member 58 as the door 24 moves to the left in the illustration and approaches the end of the range of movement. Near the end of the range of movement, the movement of the link member 44a opposes movement of the link member 44d to produce the tension T on the first cross bar member 58. The tension T is greater in the upwards direction (because pivot member 236 is offset to the right of the pivot member 136 in the illustration) and moves the door 24 upwards. It is to be recognized that the lengths of the links and the positions of the pivot members control the amount of upward (or downward) movement of the door. With such an example, it is desirable to minimize vertical movement of the door. The dimensions and positions of the various portions of the suspension assembly 34″ can be chosen to meet the needs of a particular situation. Given this description, those skilled in the art will be able to determine what will meet their needs.

In another example, the position of one of the pivot member 236 or pivot member 136 is closer to the vertical center of the door 24 (shown in phantom). This changes the angles of the corresponding elongated link members 44a, 44c or 44b, 44d and provides a door bias to an open or closed position. Optionally, the link members 44a, 44b, 44c, 44d can be made shorter or longer than illustrated to bias the door 24 toward a desired position.

The disclosed examples provide the benefits of supporting an elevator door without having to use groove guides or a conventional roller and track arrangement. The disclosed examples therefore require less maintenance and manual cleaning that was required in previously known door systems.

While the example of the door suspension assembly is described as being part of an elevator system, it is understood that the door suspension assembly can be part of other systems, such as powered entry doors for buildings, home pocket doors, train station doors, bus or train doors, barn doors, or powered sliding doors.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A door suspension assembly comprising:
a linkage adapted to suspend a door and establish an essentially straight path of door movement, at least one link member of the linkage having a portion that moves along a curved path for moving the door along the essentially straight path of door movement.

2. The assembly as recited in claim 1, wherein the curved path and the essentially straight path of door movement lie within a single plane.

3. The assembly as recited in claim 1, wherein the linkage includes a length that establishes a range of possible door movement along the essentially straight path.

4. The assembly as recited in claim 3, wherein the linkage resists movement of the door from a position near one end of the range.

5. The assembly as recited in claim 3, wherein the linkage includes a biasing member that urges the portion to move along the curved path toward a position corresponding to a door open position or a closed position.

6. The assembly as recited in claim 1, wherein the linkage includes a pivot member and the at least one link connects the pivot member and the door, and the link pivots about the pivot member such that the portion moves along the curved path when the door moves along the essentially straight path of door movement.

7. The assembly as recited in claim 1, wherein the linkage includes a crossbar rotatably connected to the door, a first link member extending between the crossbar member and a first pivot near one end of the door, and a second link member extending between the crossbar member and a second pivot near an opposite end of the door.

8. The assembly as recited in claim 1, wherein the door is an elevator door.

9. An elevator door assembly comprising:
an elevator door;
a first pivot member near one end of the elevator door;
a crossbar rotatably connected to the elevator door;
a first link extending between the crossbar and the first pivot member;
a second pivot member near an opposite end of the elevator door; and
a second link extending between the crossbar and the second pivot member, the links and the crossbar cooperating to support the elevator door and to selectively move the elevator door.

10. The assembly as recited in claim 9, including a bias member that urges at least one of the first link or the second link to pivot about the first pivot member or the second pivot member, respectively to urge the elevator door toward a desired position.

11. The assembly as recited in claim 9, wherein at least one of the first pivot member, the crossbar, or the first link includes a compliant member having a nominal dimension that changes when the elevator door moves.

12. The assembly as recited in claim 9, wherein at least one of the first link or the second link includes a resilient member having a nominal dimension that changes when the elevator door moves.

13. The assembly as recited in claim 9, wherein the first link and the second link each comprise an elongated link member connected near one end portion to the corresponding first pivot member and second pivot member and connected near an opposite end portion to the crossbar.

14. The assembly as recited in claim 13, wherein the crossbar member is rotatable about a pivot location, and the pivot location is between the opposite end portions of the elongated link members.

15. The assembly as recited in claim 9, wherein the first pivot member is mounted above the elevator door and the second pivot member is mounted below the elevator door.

16. The assembly as recited in claim 9, including a third pivot member near the one end of the elevator door and a third link extending between the third pivot member and the crossbar.

17. The assembly as recited in claim 16, wherein the crossbar comprises two crossbar portions, one of the crossbar portions is rotatably connected near one end to the third link and rotatably connected near an opposite end to the other crossbar portion and wherein the first link is rotatably connected near another end of the other crossbar portion.

18. The assembly as recited in claim 17, wherein movement of the elevator door along an essentially straight path moves a portion of at least one of the first link, second link, or third link along a curved path about the corresponding first pivot member, second pivot member, or third pivot member.

19. The assembly as recited in claim 9, wherein the first link and the second link are at least partially within a thickness of the elevator door.

20. The assembly as recited in claim 9, wherein the first pivot member and the second pivot member each include a sealed bearing.

21. An elevator door assembly comprising:
a linkage for supporting an elevator door having a first portion connected to the elevator door, a second portion connected to the first portion and having one end near a top of the elevator door, and a third portion connected to the first portion and having an end near a bottom of the elevator door, the linkage supporting a weight of the elevator door.

22. The assembly as recited in claim 21, wherein the end of the second portion is rotatably supported above the elevator door and the end of the third portion is rotatably supported below the elevator door.

23. The assembly as recited in claim 21, wherein the first portion includes a crossbar rotatably connected to the elevator door, and the second portion and the third portion each include a link that extends between the crossbar and a corresponding end of the elevator door.

24. The assembly as recited in claim 21, including a fourth portion connected to the first portion and a fourth portion end connected near one of the top or the bottom of the elevator door, and the weight of the elevator door is distributed approximately evenly among the second portion, the third portion, and the fourth portion.
